(19) United States
(12) Patent Application Publication
(10) Pub. No.: US 2026/0326039 A1
(43) Pub. Date: Oct. 22, 2026

(54) HIGH-PERMEABILITY SPIRAL-WOUND ULTRAFILTRATION MEMBRANE BASED ON IONIC LIQUID AND PREPARATION METHOD THEREFOR

(71) Applicant: Tiangong University, Tianjin (CN)

(72) Inventors: Na Chang, Tianjin (CN); Haitao Wang, Tianjin (CN); Zhaojing Jing, Tianjin (CN); Yanjun Jia, Tianjin (CN); Wei Shao, Tianjin (CN)

(73) Assignee: Tiangong University, Tianjin (CN)

(21) Appl. No.: 19/538,999

(22) Filed: Feb. 13, 2026

(30) Foreign Application Priority Data
Apr. 21, 2025 (CN) 202510496897.X

(51) Int. Cl. B01D 63/10; B01D 61/02; B01D 61/14; B01D 65/02; B01D 71/68

(52) U.S. Cl. CPC B01D 63/101; B01D 61/027; B01D 61/145; B01D 65/02; B01D 71/68

(57) ABSTRACT

The present invention relates to a high-permeability spiral-wound ultrafiltration membrane based on an ionic liquid and a preparation method therefor. The method includes: first, pouring an aqueous-phase solution containing m-phenylenediamine, an ionic liquid, camphorsulfonic acid and triethylamine onto a surface of a polysulfone ultrafiltration membrane, leaving the polysulfone ultrafiltration membrane standing, removing the aqueous-phase solution remaining on the surface to obtain a membrane I resulting from treating the polysulfone ultrafiltration membrane with the aqueous-phase solution; then, pouring an organic-phase solution containing trimesoyl chloride onto a surface of the membrane I, leaving the membrane I standing, and removing the organic-phase solution remaining on the surface of the membrane I to obtain a membrane II resulting from treating the membrane I with the organic-phase solution; and finally, performing draining, heat treatment and deionized water rinsing on the membrane II in sequence to obtain the high-permeability spiral-wound ultrafiltration membrane.

### CROSS-REFERENCES TO RELATED APPLICATIONS

This application claims the priority benefits of China application serial no. 202510496897.X, filed on Apr. 21, 2025. The entirety of the above-mentioned patent application is hereby incorporated by reference herein and made a part of this specification.

### BACKGROUND

### Technical Field

The present invention belongs to the technical field of preparation of spiral-wound ultrafiltration membranes, and in particular, relates to preparation of a high-permeability spiral-wound ultrafiltration membrane based on an ionic liquid.

### Description of Related Art

Membrane separation technologies have been widely used in fields such as food industry (desalination of soy sauce/condiments), pharmaceuticals (purification of antibiotics), biological products (desalination of polypeptides/oligonucleotides), printing and dyeing industry (separation of dyes/inorganic salts), showing advantages such as high selectivity and low energy consumption in the separation of small-molecule organic matters/inorganic salts. However, the type of membrane needs to be selected based on the target molecular weight, salt type and general properties. For traditional ultrafiltration membranes, their rejection rate can be increased (e.g., to achieve precise screening for the molecular weight of 10-100 kDa) by changing the pore size or increasing the thickness of an active layer. This, however, may increase the permeation resistance index and attenuate the flux by up to 40-60%. Moreover, the densified structure easily leads to aggravated concentration polarization to further weaken the driving force for effective mass transfer. Therefore, it is a trend to develop a separation membrane with high permeability and selectivity to meet the process requirements of “precisely separating small-molecule organic matters and inorganic salts at high flux”.

In order to improve the permeability and selectivity of the separation membrane for small-molecule organic matters/inorganic salts in wastewater, common modification methods include means such as selecting new monomers, adding competing reaction monomers and assisting interfacial polymerization (IP) reactions using porous materials, in order to improve the performance of the membrane. However, the separation membranes prepared with the aforementioned methods typically have the following problems: 1) the competition of multiple monomers may inhibit the occurrence of main reactions to lead to a relatively loose or even defective selective layer, resulting in a compromised separation effect; and 2) most of common porous materials include metal organic frames (MOFs), which can hardly achieve tight cross-linking with the membrane to a certain extent and may fall off easily, leading to relatively poor long-term operation stability.

Spiral-wound ultrafiltration membranes are often used in the separation of small-molecule organic matters and inorganic salts with the molecular weight of greater than 500 Da, for example, the separation of dyes/inorganic salts, the separation of antibiotics/inorganic salts, the separation of soy sauce/inorganic salts, etc. Furthermore, the spiral-wound ultrafiltration membranes are prepared with the interfacial polymerization method, without introduction of new monomers and porous materials, such that they can maintain certain stability during long-term operation. However, although with the screening performance for small-molecule organic matters/inorganic salts, the spiral-wound ultrafiltration membranes still have a “trade-off” problem that the permeability and the selectivity cannot be balanced. Therefore, an important object of the present invention is to prepare a novel spiral-wound ultrafiltration membrane with high permeability and high selectivity.

### SUMMARY

The technical problem to be solved by the present invention is to provide a high-permeability spiral-wound ultrafiltration membrane based on an ionic liquid with simultaneously improved permeability and separation performance, and a preparation method therefor.

To solve the technical problem above, the present invention employs a technical solution as follows: a preparation method for a high-permeability spiral-wound ultrafiltration membrane based on an ionic liquid includes the steps of:
S1, pouring an aqueous-phase solution containing m-phenylenediamine, an ionic liquid, camphorsulfonic acid and triethylamine onto a surface of a polysulfone ultrafiltration membrane, leaving the polysulfone ultrafiltration membrane standing, removing the aqueous-phase solution remaining on the surface to obtain a membrane I resulting from treating the polysulfone ultrafiltration membrane with the aqueous-phase solution;
S2, pouring an organic-phase solution containing trimesoyl chloride onto a surface of the membrane I from step S1, leaving the membrane I standing, and removing the organic-phase solution remaining on the surface of the membrane I to obtain a membrane II resulting from treating the membrane I with the organic-phase solution; and
S3, performing draining, heat treatment and deionized water rinsing on the membrane II from step S2 in sequence to obtain the high-permeability spiral-wound ultrafiltration membrane.

Further, in step S1, the ionic liquid is an imidazolium-based ionic liquid.

Further, the imidazolium-based ionic liquid is one or more of 1-ethyl-3-methylimidazolium chloride, 1-butyl-3-methylimidazolium chloride, 1-hexyl-3-methylimidazolium chloride, 1-octyl-3-methylimidazolium chloride, and 1-hexyl-3-methylimidazolium bromide.

Further, in step S1, an aqueous-phase solvent in the aqueous-phase solution is deionized water.

Further, in step S1, the m-phenylenediamine has a mass fraction of 0.03-0.1 wt. %; the camphorsulfonic acid has a mass fraction of 2.5 wt. %; the triethylamine has a mass fraction of 1.5 wt. %; and the ionic liquid has a mass fraction of 20-50 wt. %.

Further, in step S1, a standing time is 10-60 s; and in step S2, a standing time is 30-90 s.

Further, in step S2, the trimesoyl chloride has a mass fraction of 0.003-0.01 wt. %.

Further, in step S2, an organic-phase solvent in the organic-phase solution is n-hexane.

Further, in step S3, the membrane II is drained and then placed in a vacuum drying oven for heat treatment at a temperature of 60-100° C. for 1-5 min, the surface of the membrane II is rinsed multiple times with deionized water, and the membrane II is immersed in deionized water to obtain the high-permeability spiral-wound ultrafiltration membrane.

Another object of the present invention is to provide a high-permeability spiral-wound ultrafiltration membrane based on an ionic liquid, which is prepared with the preparation method for the high-permeability spiral-wound ultrafiltration membrane based on the ionic liquid.

Further, under 0.5 MPa, the high-permeability spiral-wound ultrafiltration membrane has a rejection rate up to 99.0% for Congo red, and a rejection rate of 1.06% for sodium chloride, and has a permeation flux up to 371.2 L·m⁻² h⁻¹.

Due to the technical solution described above, it can be seen that, in the present invention, the imidazolium-based ionic liquid is used as an aqueous-phase additive in the interfacial polymerization reaction, and the π-π attractive interaction between the imidazolium-based ionic liquid and the m-phenylenediamine (MPD) slows down the diffusion rate of the MPD in the interfacial polymerization reaction, improves the MPD dispersion uniformity, optimizes the pore size, and adjusts the structural morphology of aromatic polyamide, such that the high-permeability spiral-wound ultrafiltration membrane with excellent permeability and separation performance is prepared.

In summary, the present invention has beneficial effects as follows.

(1) The preparation method is simple and is easy to industrialize. As an aqueous-phase additive, the imidazolium-based ionic liquid improves the membrane separation performance without participating in the interfacial polymerization reaction. Compared with other modification methods, the preparation method is simple and convenient, and requires no additional production processes and equipment.

(2) The ionic liquid is not likely to cause damage to a polyamide separation layer or lead to leakage of a polysulfone ultrafiltration membrane. Compared with conventional modification methods such as selecting new monomers, adding competing reaction monomers and assisting IP reactions using porous materials, the introduction of an ionic liquid into the aqueous phase has the advantage that the ionic liquid exerts an effect from inside of the IP reaction without participating in the IP reaction, such that problems such as low cross-linking between the added materials and the membrane, easy shedding, and low separation efficiency are effectively avoided.

(3) The ionic liquid itself may act as a template agent to guide the ordered arrangement of polymer chains and then form a more regular porous structure or surface appearance, thereby producing beneficial effects on permeability and separation performance of the spiral-wound ultrafiltration membrane.

(4) The imidazole ring of the imidazolium-based ionic liquid and the benzene ring of the MPD may undergo a π-π interaction to adjust the diffusion rate of aqueous-phase monomers, thereby constructing an ionic liquid-MPD thin film and optimizing the pore size.

(5) The ionic liquid can change the viscosity of the aqueous phase, and adjust the micropore structure of the membrane by means of a self-assembly effect, thereby enhancing the permeability of the membrane.

(6) The high-permeability spiral-wound ultrafiltration membrane of the present invention is applicable to processes such as desalination of soy sauce/condiments, purification of antibiotics, desalination of polypeptides/oligonucleotides, and separation of dyes/inorganic salts.

### BRIEF DESCRIPTION OF THE DRAWINGS

The present invention will be described below in detail with reference to the accompanying drawings and in combination with examples, whereby the advantages and embodiments of the present invention will become more apparent. The content shown in the accompanying drawings is only intended to explain the present invention, and does not impose any limitation on the present invention in all senses. In the accompanying drawings:

FIG. 1 shows an infrared spectrum chart of the embodiments and comparative embodiments according to the present invention.

FIG. 2 shows a mean square displacement (MSD) chart of Comparative Embodiment 1 according to the present invention.

FIG. 3 shows an MSD chart of Comparative Embodiment 2 according to the present invention.

FIG. 4 shows an MSD chart of Embodiment 3 according to the present invention.

FIG. 5 shows a scanning electron microscope (SEM) image of Comparative Embodiment 1 according to the present invention.

FIG. 6 shows an SEM image of Comparative Embodiment 2 according to the present invention.

FIG. 7 shows an SEM image of Embodiment 1 according to the present invention.

FIG. 8 shows an SEM image of Embodiment 2 according to the present invention.

FIG. 9 shows an SEM image of Embodiment 3 according to the present invention.

FIG. 10 shows an SEM image of Embodiment 4 according to the present invention.

### DESCRIPTION OF THE EMBODIMENTS

For better understanding of those skilled in the art for the technical solutions of the present invention, the present invention is further illustrated in detail below in conjunction with the best embodiments.

In the embodiments and comparative embodiments below:
polysulfone ultrafiltration membranes were purchased from Qicheng (Jiangsu) Purification Technology Co., Ltd., with the pure water permeability of 500-600 L·m⁻²·h⁻¹·bar⁻¹ and the bovine serum albumin rejection rate of 90.0-90.1%;
trimesoyl chloride (TMC) was analytically pure and was purchased from Shanghai Aladdin Biochemical Technology Co., Ltd.;
m-phenylenediamine (MPD) was analytically pure and was purchased from Shanghai Aladdin Biochemical Technology Co., Ltd.;
n-hexane was analytically pure and was purchased from Shanghai Aladdin Biochemical Technology Co., Ltd.;
triethylamine was analytically pure and was purchased from Tianjin Kermel Co., Ltd.;
camphorsulfonic acid was purchased from Shanghai TCI Chemical Industry Development Co., Ltd.;
1-hexyl-3-methylimidazolium chloride (C6mimCl) was purchased from Macklin Biochemical Co. Ltd., China, with the purity of 98 wt. %;
1-ethyl-3-methylimidazolium chloride (C2mimCl) was purchased from Macklin Biochemical Co. Ltd., China, with the purity of 98 wt. %;
1-butyl-3-methylimidazolium chloride (C4mimCl) was purchased from Macklin Biochemical Co. Ltd., China, with the purity of 97 wt. %;
1-octyl-3-methylimidazolium chloride (C8mimCl) was purchased from Macklin Biochemical Co. Ltd., China, with the purity of 97 wt. %;
1-hexyl-3-methylimidazolium bromide (C6mimBr) was purchased from Macklin Biochemical Co. Ltd., China, with the purity of 98 wt. %;
Congo red (CR) was analytically pure and was purchased from Tianjin Guangfu Fine Chemical Research Institute; and
sodium chloride (NaCl) was analytically pure and was purchased from Macklin Biochemical Co. Ltd., China.

### Embodiment 1

A preparation method for a high-permeability spiral-wound ultrafiltration membrane based on an ionic liquid included the steps as follows.

In S1, a polysulfone ultrafiltration membrane was taken out from deionized water and fixed on a self-made organic frame; water droplets on the surface of the polysulfone ultrafiltration membrane were drained, and water droplets on a non-woven fabric on the back were gently absorbed; with the polysulfone ultrafiltration membrane as a support membrane, an aqueous-phase solution containing m-phenylenediamine, an ionic liquid (1-ethyl-3-methylimidazolium chloride), camphorsulfonic acid and triethylamine was poured onto the surface of the polysulfone ultrafiltration membrane; the polysulfone ultrafiltration membrane was left standing for 30 s, and then the excess aqueous-phase solution was poured away; and the aqueous-phase solution remaining on the surface was removed by rolling a rubber rod to obtain a membrane I resulting from treating the polysulfone ultrafiltration membrane with the aqueous-phase solution.

Here, the m-phenylenediamine had a mass fraction of 0.05 wt. %; the camphorsulfonic acid had a mass fraction of 2.5 wt. %; the triethylamine had a mass fraction of 1.5 wt. %; and the ionic liquid (1-hexyl-3-methylimidazolium chloride) had a mass fraction of 20 wt. %.

In S2, an n-hexane solution containing trimesoyl chloride was poured onto the surface of the membrane I from step S1; the membrane I was left standing for 60 s; and then, the organic-phase solution remaining on the surface of the membrane I was removed to obtain a membrane II resulting from treating the membrane I with the organic-phase solution.

Here, the trimesoyl chloride had a mass fraction of 0.005 wt. %.

In S3, the membrane II from step S2 was drained and then placed in a vacuum drying oven for heat treatment at a temperature of 60° C. for 3 min; then, the surface of the membrane II was rinsed multiple times with deionized water; and the membrane II was immersed in deionized water to obtain the high-permeability spiral-wound ultrafiltration membrane.

### Embodiment 2

A preparation method for a high-permeability spiral-wound ultrafiltration membrane based on an ionic liquid was the same as that in Embodiment 1, except in that in step S1, the ionic liquid (1-hexyl-3-methylimidazolium chloride) had a mass fraction of 30 wt. %.

### Embodiment 3

A preparation method for a high-permeability spiral-wound ultrafiltration membrane based on an ionic liquid was the same as that in Embodiment 1, except in that in step S1, the ionic liquid (1-hexyl-3-methylimidazolium chloride) had a mass fraction of 40 wt. %.

### Embodiment 4

A preparation method for a high-permeability spiral-wound ultrafiltration membrane based on an ionic liquid was the same as that in Embodiment 1, except in that in step S1, the ionic liquid (1-hexyl-3-methylimidazolium chloride) had a mass fraction of 50 wt. %.

### Comparative Embodiment 1

A preparation method for a high-permeability spiral-wound ultrafiltration membrane based on an ionic liquid was the same as that in Embodiment 1, except in that in step S1, the ionic liquid (1-hexyl-3-methylimidazolium chloride) had a mass fraction of 0 wt. %.

### Comparative Embodiment 2

A preparation method for a high-permeability spiral-wound ultrafiltration membrane based on an ionic liquid was the same as that in Embodiment 1, except in that in step S1, the ionic liquid (1-hexyl-3-methylimidazolium chloride) had a mass fraction of 10 wt. %.

### Comparative Embodiment 3

A preparation method for a high-permeability spiral-wound ultrafiltration membrane based on an ionic liquid was the same as that in Embodiment 1, except in that in step S1, the ionic liquid (1-hexyl-3-methylimidazolium chloride) had a mass fraction of 60 wt. %.

### Comparative Embodiment 4

A preparation method for a high-permeability spiral-wound ultrafiltration membrane based on an ionic liquid was the same as that in Embodiment 1, except in that in step S1, the ionic liquid (1-hexyl-3-methylimidazolium chloride) had a mass fraction of 70 wt. %.

### Performance Test:

A separation performance test was carried out on the high-permeability spiral-wound ultrafiltration membranes prepared in Embodiments 1 to 4 and the spiral-wound ultrafiltration membranes prepared in Comparative Embodiments 1 to 4 by using a cross-flow filtration device.

Membrane samples were placed on three parallel filtration units, and the effective area of a membrane pool was 23.76 cm². 0.1±0.001 g/L Congo red solution and 2±0.001 g/L sodium chloride solution were used as feed solutions to test the permeability and selectivity of the membranes, with the test temperature and pressure of 25±1° C. and 0.5 MPa, respectively. The dye concentrations and the salt concentrations in a feedstock solution and a permeation solution were tested using an ultraviolet spectrophotometer and a conductivity meter, respectively.

The water permeation flux was:

$${J}_{W} = \frac{Δ V}{AT}$$

Here, J_{W} indicated the water permeation flux, in L·m⁻²·h⁻¹; A indicated the effective membrane area, in m²; ΔV indicated the permeate water volume in L, as collected within a certain time T; and T indicated time in h.

The sodium chloride rejection rate was:

$${R}_{NaCl} = ( 1 - \frac{{C}_{p}}{{C}_{f}} ) \times 100 \%$$

Here, R_{NaCl} indicated the salt rejection rate in %; Cₚ indicated the NaCl concentration of the permeation solution, in mg/L; and C_{f} indicated the NaCl concentration of the feed solution, in mg/L.

The Congo red rejection rate was:

$${R}_{CR} = ( 1 - \frac{{K}_{p}}{{K}_{f}} ) \times 100 \%$$

Here, R_{CR} indicated the dye rejection rate in %; Kₚ indicated the CR concentration of the permeation solution, in mg/L; and K_{f} indicated the CR concentration of the feed solution, in mg/L.

The water permeation flux increase rate was:

$$J = ( \frac{{{J}_{W}}_{( Embodiments 1 to 4 or Comparative Embodiments 2 to 4 )}}{{{J}_{W}}_{( Comparative Embodiments 1 )}} - 1 ) \times 100 \%$$

Here, J indicated the permeation flux increase rate in %; J_{W}_{_{(Embodiments 1 to 4 or Comparative Embodiments 2 to 4)}} indicated the water permeation flux of Embodiments 1 to 4 and Comparative Embodiments 2 to 4, in L·m⁻²·h⁻¹; and J_{W}_{_{Comparative Embodiment 1)}} indicated the water permeation flux in Comparative Embodiment 1, in L·m⁻²·h⁻¹.

The separation selectivity was:

$$S = \frac{{R}_{CR}}{{R}_{NaCl}}$$

Here, S indicated the separation selectivity.

The structural parameters and performance test results of the high-permeability spiral-wound ultrafiltration membranes prepared according to Embodiments 1 to 4 and the spiral-wound ultrafiltration membranes prepared according to Comparative Embodiments 1 to 4 were shown in Table 1.

TABLE 1
Structural parameters and performance test results

| | | Water | | | | | | |
|---|---|---|---|---|---|---|---|---|
| | Water | permeation | CR | NaCl | | | | Mean |
| | permeation | flux | rejection | rejection | | Volume | Surface | pore |
| | flux | increase | rate | rate | Separation | porosity | porosity | size |
| | (L · m⁻² · h⁻¹) | rate (%) | (%) | (%) | selectivity | (%) | (%) | (nm) |
| Embodiment 1 | 131.4 | 7.00 | 99.3 | 2.18 | 45.55 | 11.76 | 5.60 | 10.77 ± |
| | | | | | | | | 1.72 |
| Embodiment 2 | 159.1 | 29.56 | 99.2 | 1.72 | 57.67 | 11.98 | 8.80 | 11.75 ± |
| | | | | | | | | 1.77 |
| Embodiment 3 | 371.2 | 202.3 | 99.0 | 1.06 | 93.40 | 13.50 | 13.30 | 12.31 ± |
| | | | | | | | | 1.19 |
| Embodiment 4 | 310.6 | 152.9 | 98.9 | 1.34 | 73.81 | 12.78 | 8.00 | 17.61 ± |
| | | | | | | | | 1.49 |
| Comparative | 122.8 | — | 98.7 | 2.22 | 44.45 | 12.31 | 9.48 | 9.95 ± |
| Embodiment 1 | | | | | | | | 2.07 |
| Comparative | 101.0 | −17.75 | 99.5 | 4.86 | 20.49 | 11.72 | 5.40 | 9.38 ± |
| Embodiment 2 | | | | | | | | 1.72 |
| Comparative | 313.2 | 155.0 | 81.7 | 1.88 | 43.46 | 14.15 | 11.26 | 19.64 ± |
| Embodiment 3 | | | | | | | | 1.90 |
| Comparative | 333.4 | 171.5 | 81.4 | 1.92 | 42.40 | 14.11 | 11.48 | 20.31 ± |
| Embodiment 4 | | | | | | | | 2.60 |

From the results in Table 1, compared with Comparative Embodiment 1 with no imidazolium-based ionic liquid added, Embodiments 1 to 4 showed gradually increased permeability, with the water permeation flux greater than 122.8 L·m⁻²·h⁻¹ in each case, and when the content of the imidazolium-based ionic liquid was 40 wt. % (Embodiment 3), the highest water permeation flux of 371.2 L·m⁻²·h⁻¹ was achieved. Furthermore, compared with Comparative Embodiment 1, Embodiments 1 to 4 also showed gradually increased separation performance, with the Congo red rejection rate of greater than 98.9% and the separation selectivity of greater than 44.45 in each case, and the highest separation selectivity was found in Embodiment 3, which was up to 93.4. Therefore, with such a high separation performance, the permeability of each membrane was significantly improved. The separation selectivity of Comparative Embodiments 2 to 4 was all lower than that of Comparative Embodiment 1 (44.45), the water permeation flux of the Comparative Embodiment 2 was attenuated by 17.75%, the Congo red rejection rates of Comparative Embodiments 3 to 4 were reduced to 81.7% and 81.4%, respectively, making them unsuitable for the high-permeability spiral-wound ultrafiltration membrane system of the present invention.

Furthermore, the intermolecular interaction energy between MPD and the imidazolium-based ionic liquid was calculated at different concentrations of the imidazolium-based ionic liquid, respectively:

Eᵢₙₜ=E_{A+B}E_{A}−E_{B},

Here, Eᵢₙₜ indicated the intermolecular interaction energy between MPD and the imidazolium-based ionic liquid, in kcal/mol; E_{A+B} indicated the total energy of the MPD and the imidazolium-based ionic liquid in the system, in kcal/mol; E_{A} indicated the energy of MPD in the system, in kcal/mol; and E_{B} indicated the energy of the imidazolium-based ionic liquid in the system, in kcal/mol.

Table 2 shows the intermolecular interaction energies between imidazolium-based ionic liquid (C6mimCl) molecules and MPD in Embodiment 3 and Comparative Embodiment 2, i.e., the intermolecular interaction energies between C6mimCl molecules at different concentrations and the MPD.

TABLE 2
Intermolecular interaction energy between C6mimCl
molecules and MPD at different concentrations

| | Eᵢₙₜ | E_{A+B} | E_{A} | E_{B} |
|---|---|---|---|---|
| | (kcal/mol) | (kcal/mol) | (kcal/mol) | (kcal/mol) |
| Comparative | −542.08 | −24471.82 | −2323.27 | 18.15 |
| Embodiment 2 | | | | |
| Embodiment 3 | −1506.37 | −24958.73 | −2217.79 | −473.98 |

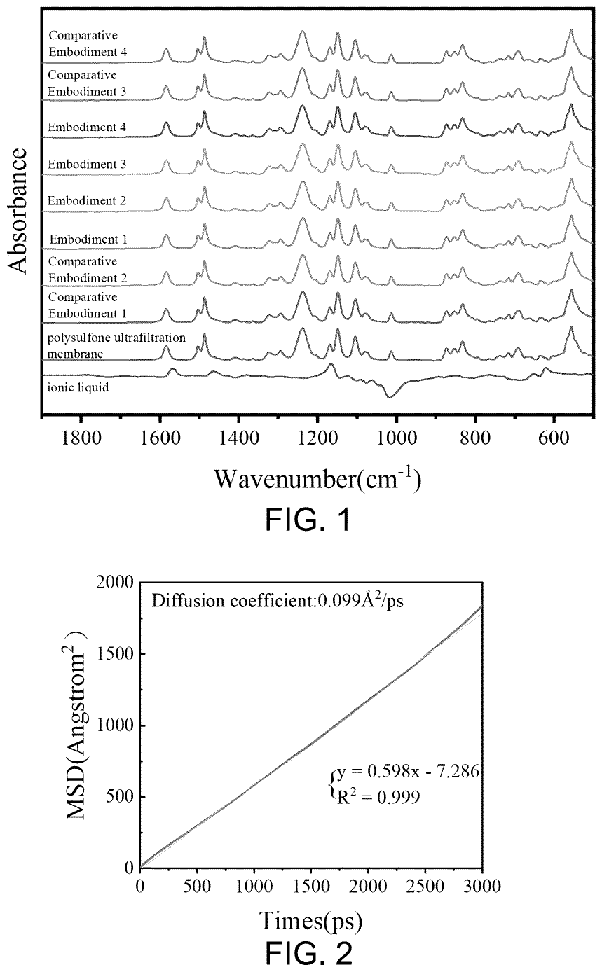

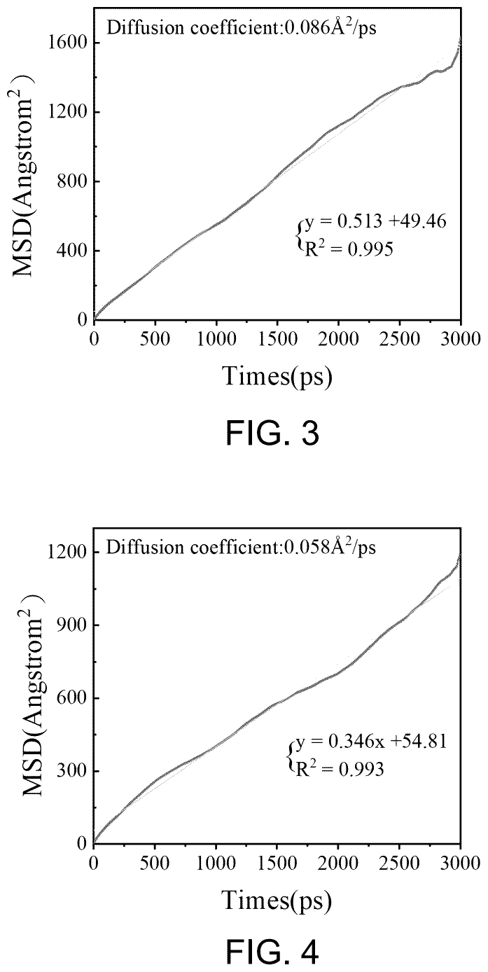

According to the molecular simulation data in Table 2, the intermolecular interaction energies between the imidazolium-based ionic liquid (C6mimCl) and the MPD in Comparative Embodiment 2 and Embodiment 3 were −542.08 kcal/mol and −1506.37 kcal/mol, respectively, both of which were negative values, indicating intermolecular π-π attractive interaction forces, which increased with the gradual increase of the mass concentration of the imidazolium-based ionic liquid added to the aqueous phase. With reference to the MSD curves in FIGS. 2 to 4 (Comparative Embodiments 1 and 2 and Embodiment 3), the diffusion rate of the MPD monomers gradually decreased with the increase of the concentration of the imidazolium-based ionic liquid. Furthermore, from FIG. 1, both Embodiments 1 to 4 and Comparative Embodiments 1 to 4 exhibited successfully formed polyamide structures without the emergence of new functional groups, and the imidazolium-based ionic liquid did not participate in the IP reaction.

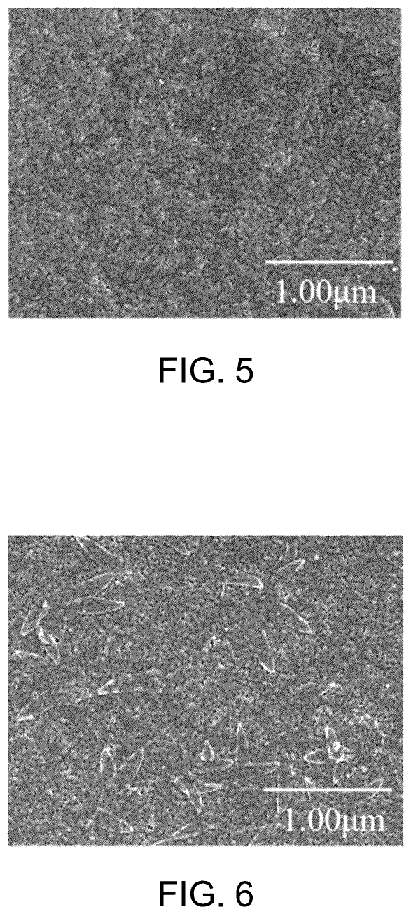

From Table 1 and the SEM images of the membrane surfaces in FIGS. 5 and 6, when the mass concentration of the added imidazolium-based ionic liquid was 10 wt. %, the density of the leaf structures formed on the membrane surface increased, and the spiral-wound ultrafiltration membrane showed reduced volume porosity from 12.31% to 11.72%, reduced surface porosity from 9.48% to 5.40%, and reduced mean pore size from 9.95 nm to 9.38 nm, resulting in an increase in Congo red rejection rate and a decrease in water permeation flux.

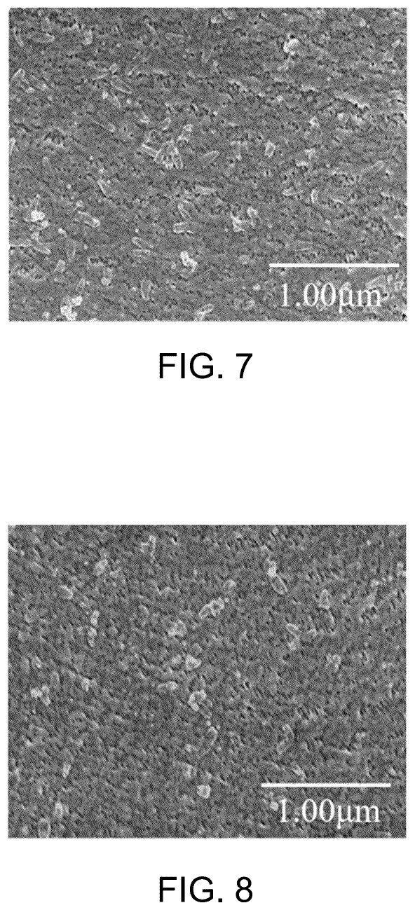

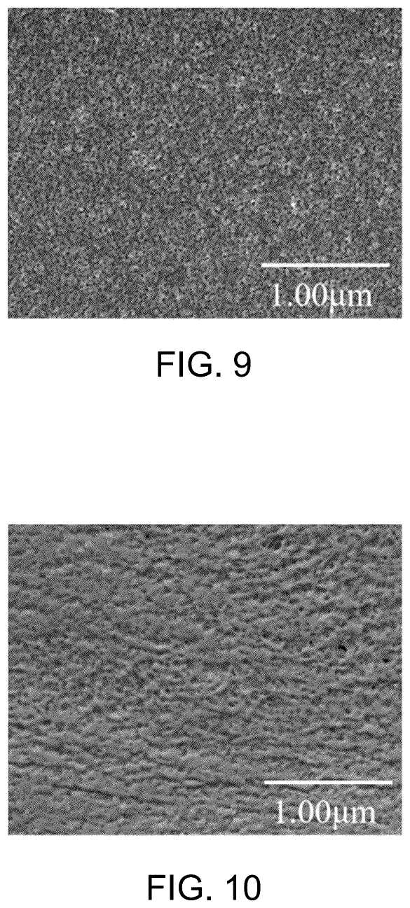

From Table 1 and FIGS. 7 to 10, the leaf structures on the membrane surface gradually decreased until smoothness. Compared with Comparative Embodiment 1, Embodiments 1 to 4 showed the gradually increased mean pore size from 9.95 nm to 17.61 nm and the reduced range of pore size distribution, such that the high-permeability spiral-wound ultrafiltration membrane prepared according to the present invention was increased in membrane pore uniformity. That is, the added imidazolium-based ionic liquid increased the permeability of the membrane and narrowed the pore size distribution of the spiral-wound ultrafiltration membrane, such that the permeability and separation performance were improved at the same time. This demonstrated the significant effect of the imidazolium-based ionic liquid on improvement of permeability of the spiral-wound ultrafiltration membrane.

The above results indicated that the π-π attractive interaction between the imidazolium-based ionic liquid and the MPD caused MPD to aggregate under the attractive effect in the presence of the low-concentration imidazolium-based ionic liquid, allowing for complete reaction of MPD with TMC, which improved the membrane compactness and reduced the porosity, mean pore size and water permeation flux (Comparative Embodiment 2). On the contrary, as the concentration of the imidazolium-based ionic liquid increased, the MPD diffusion rate was slowed down, the MPD dispersion uniformity and the membrane pore uniformity were improved, the pore size distribution was narrowed, and at the same time, the permeability and separation performance of the spiral-wound ultrafiltration membrane were improved (Embodiments 1 to 4, Table 1). When the concentration of the imidazolium-based ionic liquid was excessively high (Comparative Embodiments 3 and 4), the MPD diffusion rate was slowed too much, preventing the normal interfacial polymerization reaction, and leading to blockage and leakage of the membrane structure and thus a significant decrease in the Congo red rejection rate. Therefore, when used as the aqueous-phase additive for preparation of the high-permeability spiral-wound ultrafiltration membrane, the imidazolium-based ionic liquid had the optimal concentration range of 20-50 wt. % and the optimal concentration of 40 wt. %.

Similarly, in a case where the imidazolium-based ionic liquid was 1-ethyl-3-methylimidazolium chloride, 1-butyl-3-methylimidazolium chloride, 1-octyl-3-methylimidazolium chloride, or 1-hexyl-3-methylimidazolium bromide, the imidazolium-based ionic liquid also had the optimal concentration range of 20-50 wt. % and the optimal concentration of 40 wt. % when used as the aqueous-phase additive for preparation of the high-permeability spiral-wound ultrafiltration membrane.

In summary, by taking the imidazolium-based ionic liquid as the aqueous-phase additive, the present invention reduces the MPD diffusion rate by means of the π-π attractive interaction, adjusts the interfacial polymerization reaction and narrows the pore size distribution, thereby improving the separation performance of the spiral-wound ultrafiltration membrane for small-molecule organic matters/inorganic salts and the permeability of the membrane.

The high-permeability spiral-wound ultrafiltration membrane prepared according to the present invention is applicable to wastewater treatment in fields such as food industry, pharmaceuticals, biological products, and printing and dyeing industry, in particular to processes such as desalination of soy sauce/condiments, purification of antibiotics, desalination of polypeptides/oligonucleotides, and separation of dyes/inorganic salts.

The embodiments of the present invention were illustrated in detail above, the disclosure of which, however, only provides preferred embodiments of the present invention and should not be construed as limiting the scope of implementation of the present invention. Any changes, improvements and the like made within the scope of the present invention shall still fall within the scope coved by the present invention.

What is claimed is:

1. A preparation method for a high-permeability spiral-wound ultrafiltration membrane based on an ionic liquid, comprising the steps of:
S1, pouring an aqueous-phase solution containing m-phenylenediamine, an ionic liquid, camphorsulfonic acid and triethylamine onto a surface of a polysulfone ultrafiltration membrane, leaving the polysulfone ultrafiltration membrane standing, removing the aqueous-phase solution remaining on the surface to obtain a membrane I resulting from treating the polysulfone ultrafiltration membrane with the aqueous-phase solution;
S2, pouring an organic-phase solution containing trimesoyl chloride onto a surface of the membrane I from step S1, leaving the membrane I standing, and removing the organic-phase solution remaining on the surface of the membrane I to obtain a membrane II resulting from treating the membrane I with the organic-phase solution; and
S3, performing draining, heat treatment and deionized water rinsing on the membrane II from step S2 in sequence to obtain the high-permeability spiral-wound ultrafiltration membrane.

2. The preparation method for the high-permeability spiral-wound ultrafiltration membrane based on the ionic liquid according to claim 1, wherein: in step S1, the ionic liquid is an imidazolium-based ionic liquid.

3. The preparation method for the high-permeability spiral-wound ultrafiltration membrane based on the ionic liquid according to claim 2, wherein: the imidazolium-based ionic liquid is one or more of 1-ethyl-3-methylimidazolium chloride, 1-butyl-3-methylimidazolium chloride, 1-hexyl-3-methylimidazolium chloride, 1-octyl-3-methylimidazolium chloride, and 1-hexyl-3-methylimidazolium bromide.

4. The preparation method for the high-permeability spiral-wound ultrafiltration membrane based on the ionic liquid according to claim 1, wherein: in step S1, the m-phenylenediamine has a mass fraction of 0.03-0.1 wt. %; the camphorsulfonic acid has a mass fraction of 2.5 wt. %; the triethylamine has a mass fraction of 1.5 wt. %; and the ionic liquid has a mass fraction of 20-50 wt. %.

5. The preparation method for the high-permeability spiral-wound ultrafiltration membrane based on the ionic liquid according to claim 1, wherein: in step S1, an aqueous-phase solvent in the aqueous-phase solution is deionized water; and in step S2, an organic-phase solvent in the organic-phase solution is n-hexane.

6. The preparation method for the high-permeability spiral-wound ultrafiltration membrane based on the ionic liquid according to claim 1, wherein: in step S1, a standing time is 10-60 s; and in step S2, a standing time is 30-90 s.

7. The preparation method for the high-permeability spiral-wound ultrafiltration membrane based on the ionic liquid according to claim 1, wherein: in step S2, the trimesoyl chloride has a mass fraction of 0.003-0.01 wt. %.

8. The preparation method for the high-permeability spiral-wound ultrafiltration membrane based on the ionic liquid according to claim 1, wherein: in step S3, the membrane II is drained and then placed in a vacuum drying oven for heat treatment at a temperature of 60-100° C. for 1-5 min, the surface of the membrane II is rinsed multiple times with deionized water, and the membrane II is immersed in deionized water to obtain the high-permeability spiral-wound ultrafiltration membrane.

9. A high-permeability spiral-wound ultrafiltration membrane prepared with the preparation method for the high-permeability spiral-wound ultrafiltration membrane based on the ionic liquid according to claim 1.

10. The high-permeability spiral-wound ultrafiltration membrane according to claim 9, wherein: under 0.5 MPa, the high-permeability spiral-wound ultrafiltration membrane has a rejection rate up to 99.0% for Congo red, and a rejection rate of 1.06% for sodium chloride, and has a permeation flux up to 371.2 L·m⁻² h⁻¹.
